(19) United States
(12) Patent Application Publication
(10) Pub. No.: US 2005/0015230 A1
(43) Pub. Date: Jan. 20, 2005

(54) Axial stability in rock bits

(76) Inventors: Prabhakaran Centala, The Woodlands, TX (US); Mohamed Boudrare, Houston, TX (US); Sujian Huang, Houston, TX (US)

Correspondence Address: OSHA & MAY L.L.P., 1221 MCKINNEY STREET, HOUSTON, TX, 77010, US

(21) Appl. No.: 10/890,524

(22) Filed: Jul. 13, 2004

Related U.S. Application Data
(60) Provisional application No. 60/487,495, filed on Jul. 15, 2003.

(51) Int. Cl. G06G 7/48

(52) U.S. Cl. 703/10; 703/2

(57) ABSTRACT

A method for designing a bit for boring earth formations includes defining parameters for a calculation, where the parameters relate to a geometry of the bit, calculating to determine interference between the bit and the earth formations, obtaining vertical displacements with respect to a bit revolution based on the interference between the bit and the earth formations and applying a criterion to the vertical displacements to evaluate bit performance.

### CROSS-REFERENCE TO RELATED APPLICATIONS

This is an utility application, which claims priority pursuant to 35 U.S.C. §119(c) to U.S. Provisional Application No. 60/487,495, filed on Jul. 15, 2003. That application is expressly incorporated by reference it its entirety.

### BACKGROUND OF INVENTION

Roller cone rock bits and fixed cutter bits are commonly used in the oil and gas industry for drilling wells. FIG. 1 shows one example of a conventional drilling system drilling an earth formation. The drilling system includes a drilling rig (10) used to turn a drill string (12), which extends downward into a well bore (14). Connected to the end of the drill string (12) is roller cone-type drill bit (20) via a bottom hole assembly (16). A roller cone-type drill bit is shown in further detail in FIG. 2. Roller cone bits (20) typically comprise a bit body (22) having an externally threaded connection at one end (24), and a plurality of roller cones (26) (usually three as shown) attached to the other end of the bit and able to rotate with respect to the bit body (22). Attached to the cones (26) of the bit (20) are a plurality of cutting elements (28) typically arranged in rows about the surface of the cones (26). The cutting elements (28) are typically tungsten carbide inserts, polycrystalline diamond compacts, or milled steel teeth.

Significant expense is involved in the design and manufacture of drill bits. Therefore, having accurate models for simulating and analyzing the drilling characteristics of bits can greatly reduce the cost associated with manufacturing drill bits for testing and analysis purposes. For this reason, several models have been developed and employed for the analysis and design of fixed cutter bits. These fixed cutter simulation models have been particularly useful in that they have provided a means for analyzing the forces acting on the individual cutting elements on the bit, thereby leading to the design of, for example, force-balanced fixed cutter bits and designs having optimal spacing and placing of cutting elements on such bits. By analyzing forces on the individual cutting elements of a bit prior to making the bit, it is possible to avoid expensive trial and error designing of bit configurations that are effective and long lasting.

However, roller cone bits are more complex than fixed cutter bits in that cutting surfaces of the bit are disposed on the roller cones, wherein each roller cone independently rotates relative to the rotation of the bit body about axes oblique to the axis of the bit body. Additionally, the cutting elements of the roller cone bit deform the earth formation by a combination of compressive fracturing and shearing, whereas fixed cutter bits typically deform the earth formation substantially entirely by shearing. The bit's contact with the earth formation may result in small upward and downward displacements of the bit itself (and/or a bottom hole assembly). This vertical movement is characterized as “bit bounce.” A bit's axial stability is based on the amount of bit bounce that occurs during a drilling operation. Some bit bounce is to be expected during a drilling operation, however, substantial fluctuations in vertical movements result in axial instability. Thus, bit bounce is typically undesirable, because it results in vibrations in the drill string causing inefficiency in the drilling operation and, in some cases, potentially damaging the bit prematurely.

Accurate analysis of the drilling performance of roller cone bits requires more complex models than for fixed cutter bits. Until recently, no reliable roller cone bit models had been developed which could take into consideration the location, orientation, size, height, and shape of each cutting element on the roller cone, and the interaction of each individual cutting element on the cones with earth formations during drilling.

In recent years, some researchers have developed a method for modeling roller cone cutter interaction with earth formations. See D. Ma et al, The Computer Simulation of the Interaction Between Roller Bit and Rock, paper no. 29922, Society of Petroleum Engineers, Richardson, Tex. (1995).

There is a great need to optimize performance of roller cone bits drilling earth formations, particularly with respect to the axial stability of the bits. The axial stability of a bit relates to extent that the bit moves along the axis of the bit (or drill string) during drilling. The axial stability is a function of the weight-on-bit and the reaction forces exerted on the bit by the bottom of the borehole. Any axial instability during drilling will have a negative impact on the bit and the drill string. In addition, axial instability also reduces drilling efficiency. Therefore, it is desirable to have methods for analyzing axial stability of a roller cone bit and for optimizing a roller cone bit to have an improved axial stability.

### SUMMARY OF INVENTION

In general, one aspect of the invention relates to a method for designing a bit for boring in earth formations. The method includes defining parameters for a calculation, wherein the parameters relate to a geometry of the bit, calculating to determine interference between the bit and the earth formations, obtaining vertical displacements with respect to a bit revolution based on the interference between the bit and the earth formations, and applying a criterion to the vertical displacements to evaluate bit performance.

In general, one aspect of the invention relates to a system for designing a bit for boring in an earth formation. The system includes means for defining parameters for a calculation, wherein the parameters relate to a geometry of the bit, calculating to determine interference between the bit and the earth formations, means for obtaining vertical displacements with respect to a bit revolution based on the interference between the bit and the earth formations, and means for applying a criterion to the vertical displacements to evaluate bit performance.

In general, one aspect of the invention relates to a method for designing a bottom hole assembly for boring earth formations. The method includes defining parameters for a calculation, wherein the parameters relate to a geometry of a bit of the bottom hole assembly, calculating to determine interference between the bit and the earth formations, obtaining vertical displacements with respect to a bit revolution based on the interference between the bit and the earth formations, and applying a criterion to the vertical displacements to evaluate bit performance with the bottom hole assembly.

In general, one aspect of the invention relates to a method for designing a bit for boring earth formation. The method includes graphically displaying vertical displacements of the bit interfering with the earth formation, and applying a criterion to the vertical displacements to evaluate bit performance.

In general, one aspect of the invention relates to a method for designing a bottom hole assembly for boring earth formation. The method includes graphically displaying vertical displacements of the bottom hole as a bit of the bottom hole assembly interferes with the earth formation, and applying a criterion to the vertical displacements to evaluate bit performance with the bottom hole assembly.

Other aspects and advantages of the invention will be apparent from the following description and the appended claims.

### BRIEF DESCRIPTION OF DRAWINGS

FIG. 1 shows a schematic diagram of a drilling system for drilling earth formations having a drill string attached at one end to a bit.

FIG. 2 shows a perspective view of a roller cone drill bit.

FIG. 3 shows a flow chart for analyzing axial stability in accordance with an embodiment of the present invention.

FIG. 4 shows a cutting element schematic of cutting element interference with earth formations.

FIGS. 5-7 show an applied weight-on bit and a resultant vertical reaction force.

FIG. 8 shows a localized bit bounce curve in accordance with an embodiment of the present invention.

FIG. 9 shows a generalized bit bounce curve in accordance with an embodiment of the present invention.

FIG. 10 shows a three-dimensional bottom hole profile in accordance with an embodiment of the present invention.

FIG. 11 shows a two-dimensional bottom hole profile in accordance with an embodiment of the present invention.

FIG. 12 shows a window of steady-state generalized bit bounce curves in accordance with an embodiment of the present invention.

FIG. 13 shows a graphical representation of a set of generalized bit bounce curves in accordance with an embodiment of the present invention.

FIG. 14 shows a computer generated graphical representation of a bottom hole profile in accordance with an embodiment of the present invention.

FIG. 15 shows a computer system for analyzing axial stability in rock bits in accordance with an embodiment of the present invention.

FIGS. 16 and 17 are exemplary graphical representations of generalized bit bounce curves in accordance with an embodiment of the present invention.

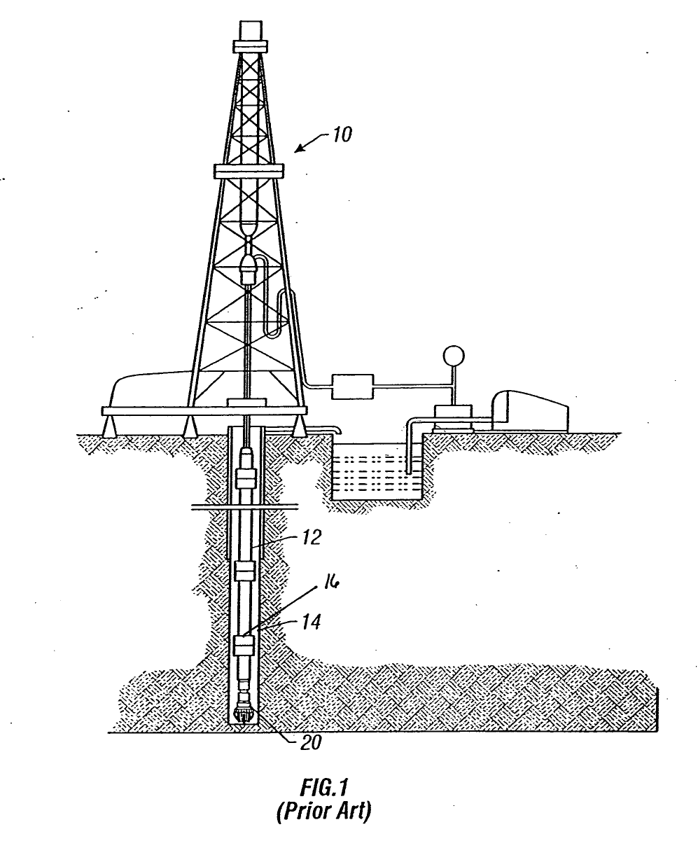

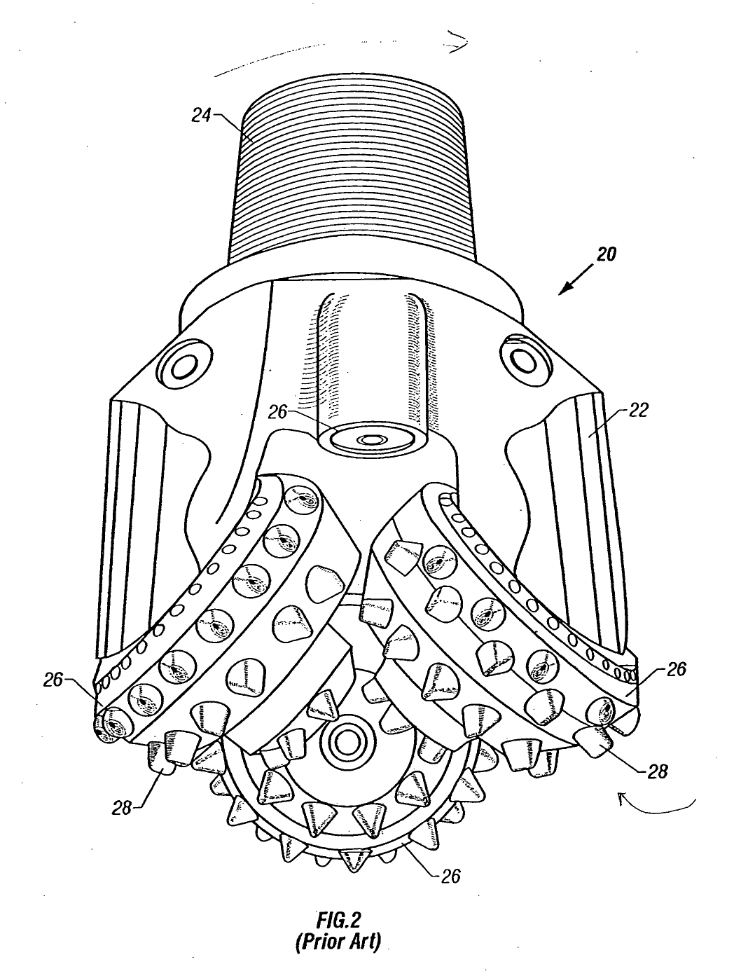

### DETAILED DESCRIPTION

The present invention involves analyzing axial stability through simulation to evaluate cutting structure performance, e.g., ROP, footage drilled, etc. In general, the present invention involves defining a set of parameters of a cutting structure during a drilling operation in a simulation and executing the simulation in view of the defined parameters. The present invention further involves obtaining vertical movements with respect to revolution of the cutting structure and applying a criterion to the vertical movements to evaluate the cutting structure performance.

In one or more embodiments, the present invention may generally be characterized as comprising three phases: simulation, analysis, and optimization. In the first phase, simulation includes defining a design of a bit for drilling into the earth formations and representing the bit during a drilling operation. One example of a method for simulating a bit drilling through earth formations can be found in U.S. Pat. No. 6,516,293, assigned to the assignee of the present invention, and now incorporated herein by reference in its entirety. Next, the analysis phase involves extracting data from the simulation phase and generating a representation of the data so that a criterion may be applied. Finally, based on whether the bit satisfies the criterion, the design of the bit design may be modified in an optimization phase.

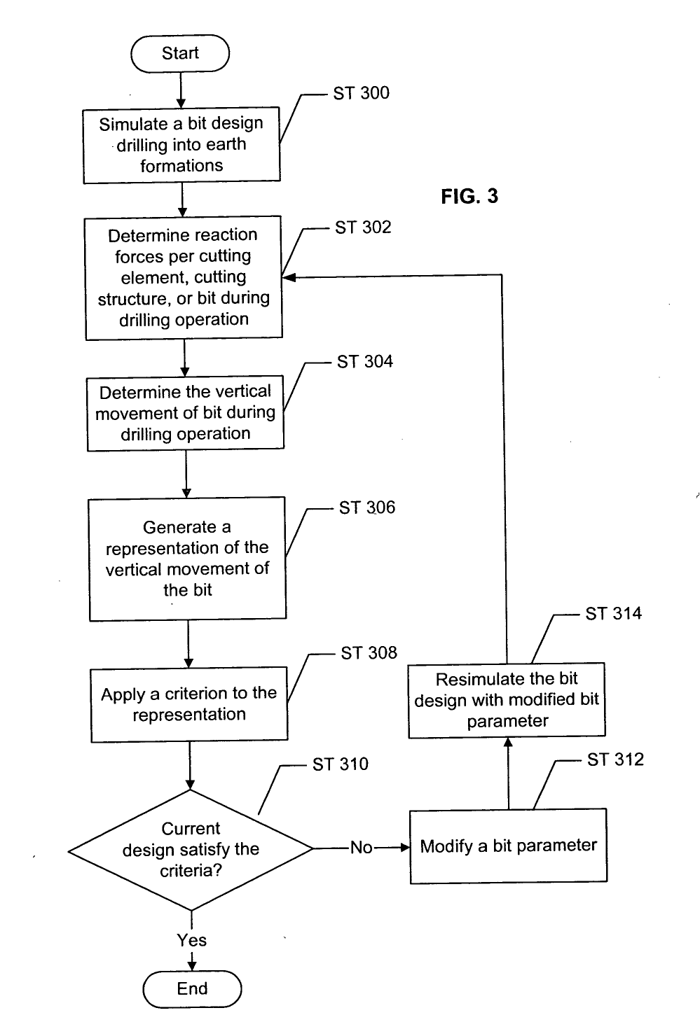

FIG. 3 shows a flow chart of analyzing axial stability of a bit in accordance with an embodiment of the present invention. In FIG. 3, the simulation phase comprises Steps 300 and 302. Initially, a design of a bit for drilling into earth formations is defined (Step 300). The bit is simulated during a drilling operation contacting the earth formations. Based on the contact between the earth formations and the bit, a resultant reaction force is determined (Step 302).

A roller cone bit (rock bit) typically includes one or more roller cones. Each roller cone typically includes a plurality of cutting elements (teeth) arranged in one or more rows. Thus, the resultant reaction force of a rock bit may be a sum of reaction force of each individual roller cone. The reaction force of each roller cone in turn may reflect a sum of all reaction forces of the plurality of cutting elements. Accordingly, factors that may influence the resultant reaction force of a rock bit may include, for example, the number of roller cones, the configuration of the roller cones on the rock bit, the configuration and number of cutting elements on each roller cone, etc. In addition, the properties (formation properties) and the bottom hole shape may also influence the resultant reaction forces experienced by the rock bit.

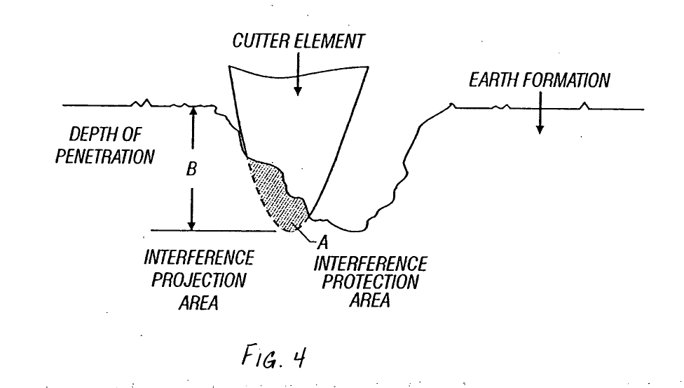

In one or more embodiments, the resultant reaction force of a rock bit is based on the sum of reaction forces of the individual cutting elements (or teeth) as they contact the earth formations. These reaction forces are a function of both the depth of penetration (B) of individual cutting elements in view of the interference projection area (A) as shown in FIG. 4.

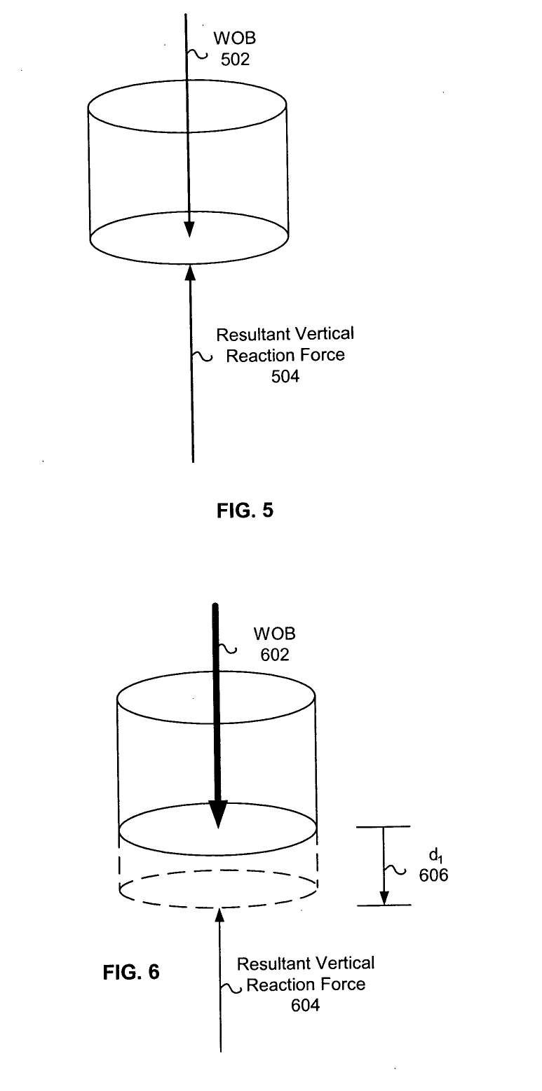

FIG. 5 shows a resultant vertical reaction force and a weight-on-bit (WOB). The WOB (502) is a vertical force applied to the bit via a drill string (not shown). In FIG. 5, the resultant vertical reaction force (504) and the WOB (502) are equal and opposite forces, meaning that the amount of force applied to the bit is equal to the amount of force exerted by the earth formations having contact with the bit. Because the WOB and the resultant reaction force are equal and opposite forces, the bit is not displaced in an upward or downward direction.

However, when the WOB (602) is greater than the resultant vertical reaction force (604) as in FIG. 6, the bit is displaced in a downward direction (d₁ 606) by a distance directly proportional to the difference between the WOB (602) and the resultant vertical reaction force (604). In other words, the greater the difference between the WOB and the resultant vertical reaction force, the bit is displaced in a downward direction by a greater distance. This downward displacement is considered positive vertical movement, because the bit is penetrating further into the earth formations, i.e., the footage drilled is increasing with respect to the bit revolution.

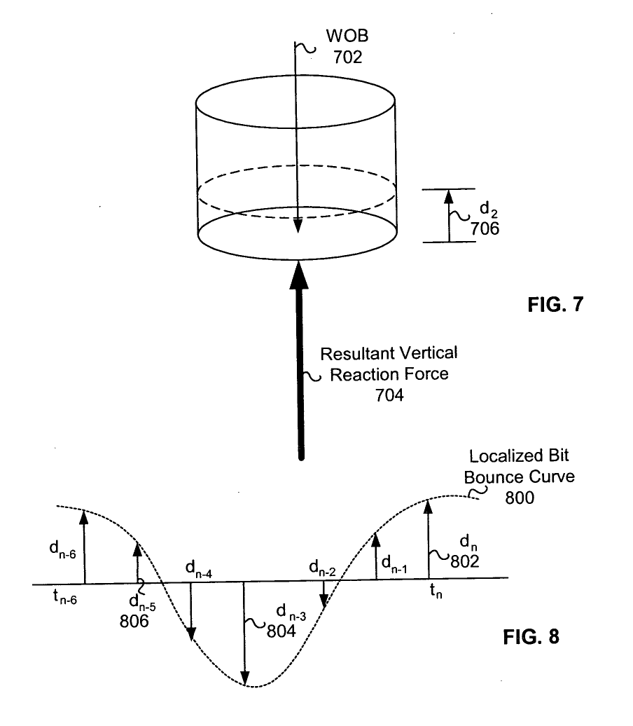

Conversely, when the WOB (702) is less than the resultant vertical reaction force (704) as in FIG. 7, the bit is displaced in an upward direction (d₂ 706) through a distance directly proportional to the difference between the WOB (702) and the resultant vertical reaction force (704). Accordingly, the greater the difference between the WOB and the resultant vertical reaction force, the bit is displaced in an upward direction by a greater distance. This upward displacement is considered negative vertical movement, because the bit is not penetrating further into the earth formations, i.e., the footage drilled is not increasing with respect to the bit revolution.

One skilled in the art will appreciated that determining the vertical movements of a drill bit may include additional forces and the vertical movements of the drill bit may be calculated in a variety of ways.

Referring back to FIG. 3, after the resultant reaction force is determined, the analysis phase begins, which comprises Steps 304-310. In the analysis phase, the vertical movements of the bit during the drilling operation are obtained (Step 304). The vertical movements of the bit may be obtained during incremental revolutions or times steps or at the conclusion of the simulation. A representation of the obtained vertical movements may be generated. Representations of the obtained vertical movements include, but are not limited to graphs, tables, computer generated graphics, etc.

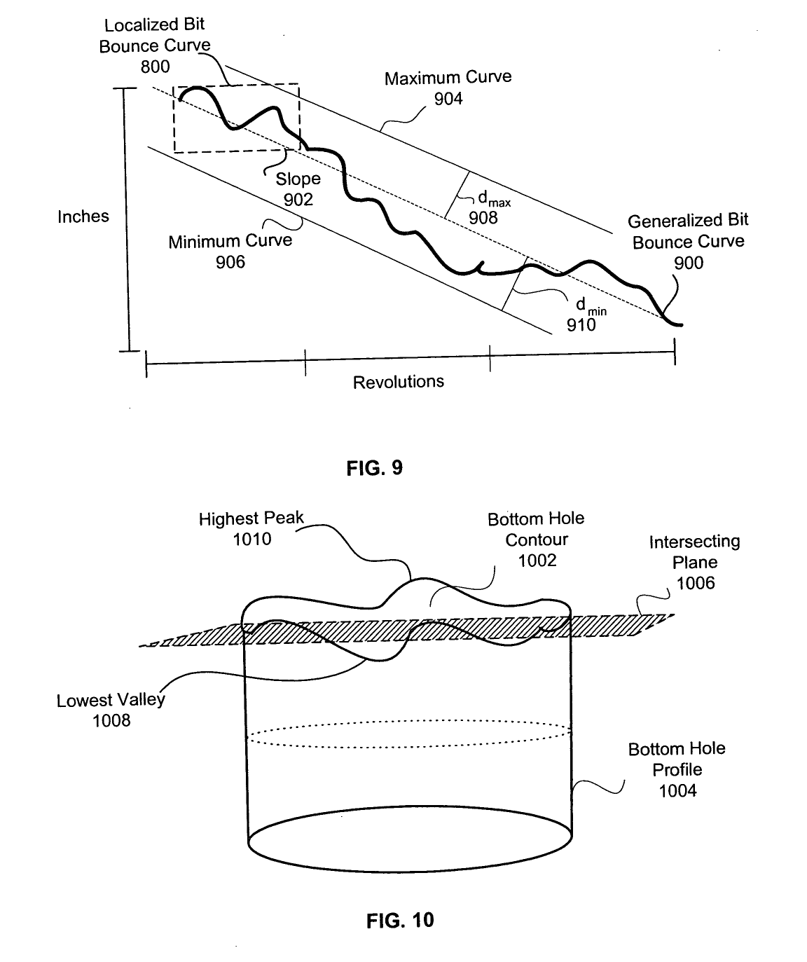

FIG. 8 shows a representation of the obtained vertical movements in accordance with an embodiment of the present invention. In FIG. 8, several vertical movements at particular increments of time (or fractions of a revolution of the bit) are shown as dₓ, where x is n-6 to n. Mapping these vertical movements produces a localized bit bounce curve (800), which indicates the vertical movements of the bit during a drilling operation with respect to bit revolution. For example, vertical movements (802, 804, 806) indicate the bit's movement with respect to the bit revolution at three different times during drilling. Vertical movements (802, 806) show negative displacement of the bit, whereas vertical movement (804) shows positive displacement of the bit. FIG. 8 shows a localized perspective of the obtained vertical movements, whereas FIG. 9 shows a generalized representation of the obtained vertical movements. For example, the bit bounce curve (800) is a sub-section of a bit bounce curve (900). The generalized bit bounce curve indicates the distance (inches or centimeters) a bit moves with respect to a bit revolution.

The generalized bit bounce curve (900) has a generally positive slope indicating that the bit is drilling through the earth formations. The slope (902) of a bit bounce curve (900) approximates the rate of penetration, which is the rate a bit cuts through the earth formations. Accordingly, a higher slope indicates a greater rate of penetration.

Additionally, the bit bounce curve (900) may be measured over three revolutions of three hundred-sixty degrees (360°) of the bit through the earth formation. For example, the localized bit bounce curve (800) is measured over one revolution through the earth formation. Preferably, the displacement of the bit is obtained at every three degrees (3°); therefore, the localized bit bounce curve comprises one hundred-twenty data points (all of which are not shown in FIG. 8). As such, the bit bounce curve includes three hundred-sixty data points over three revolutions, which map the vertical displacement of the bit with respect to inches. One skilled in the art will appreciate that neither the number of data points nor the particular incremental rotation (or time step) are limitations of the present invention.

In one or more embodiments, spikes or aberrations may be present in a bit bounce curve, which is typical of insert-rock interaction. Additionally, in on or more embodiments, a bit bounce curve may have a wavy and/or sinusoidal shape.

The analysis phase continues, after a representation of the vertical movement of the bit has been generated, when a criterion is applied to the generated representation (Step 308). In one or more embodiments, the criterion relates to a standard of axial stability. In one or more embodiments, various characteristics may be compiled to generate a criterion by which the axial stability of a bit may be determined.

For example, the criterion may limit a number of spikes in a bit bounce curve or require a slope of the bit bounce curve to be substantially straight, rather than wavy or the criterion may eliminate the sinusoidal shape of the bit bounce curve. One skilled in the art will understand that the sinusoidal shape of the bit bounce curve typically results in the planar surface of the bottom hole being saddle-shaped, which prevents the bit from performing optimally.

Alternatively, the criterion may also define minimum and/or maximum fluctuations in the vertical displacement of the bit. For example, referring to FIG. 9, maximum and minimum curves (904, 906) are lines of equal slope (902) of the bit bounce curve, indicating the upper and lower limits of the desired vertical displacement of the bit. In other words, if the bit where to be displaced above or below maximum and minimum curves (904, 906), then the axial stability of the bit may not be optimal. The desired vertical displacements are measured as dₘₐₓ (908) and dₘᵢₙ (910). In one or more embodiments, dₘₐₓ (908) and dₘᵢₙ (910) may be equal, however, this is not a limitation of the present invention. Additionally, in one or more embodiments, dₘₐₓ (908) and/or dₘᵢₙ (910) is less than or equal to one inch (25.4 mm) in three revolutions through the formation. In other words, in a preferred embodiment, the bit is not displaced by more than an inch in a positive or negative direction during drilling. One of ordinary skill in the art will appreciate that the maximum and minimum displacements are dependent on various characteristics, e.g., the properties of the earth formation. Further, one skilled in the art will understand that a minimum curve is the maximum displacement in the positive direction, whereas the maximum curve is the maximum displacement in the negative direction.

In FIG. 9, the generalized bit bounce curve (900) does not exceed the maximum and minimum curves (904, 906). If the bit bounce curve (900) were to exceed the curves (904, 906), a design engineer may desire to eliminate or reduce the amount by which the bit bounce curve (900) exceeds the maximum and/or minimum curves (904, 906).

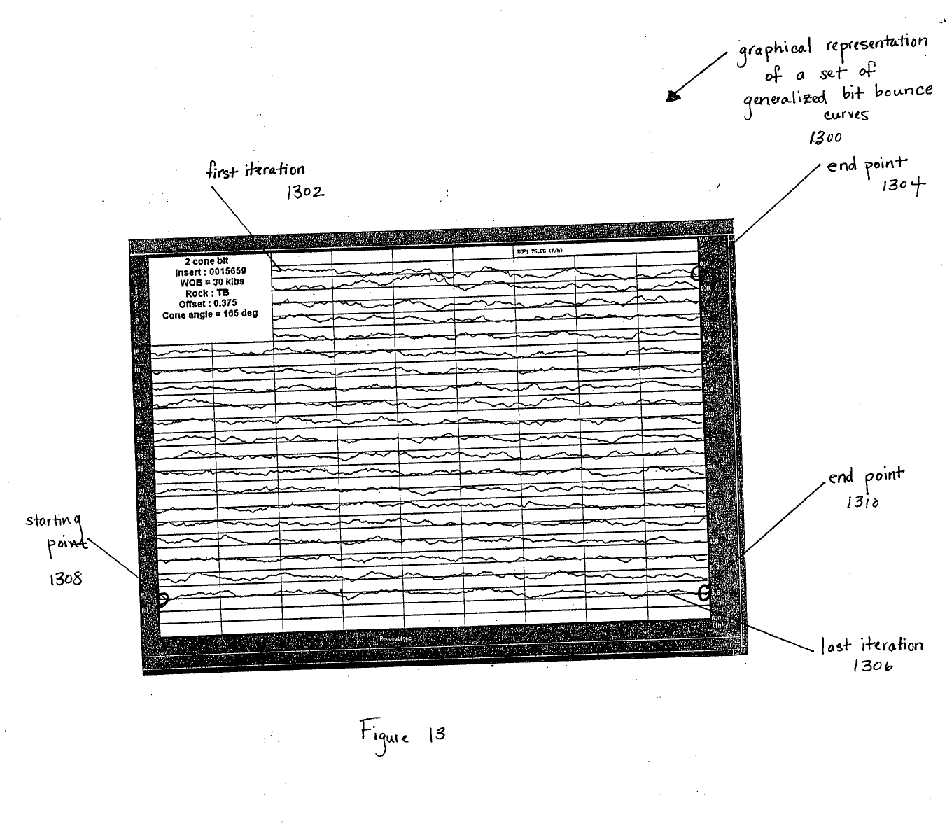

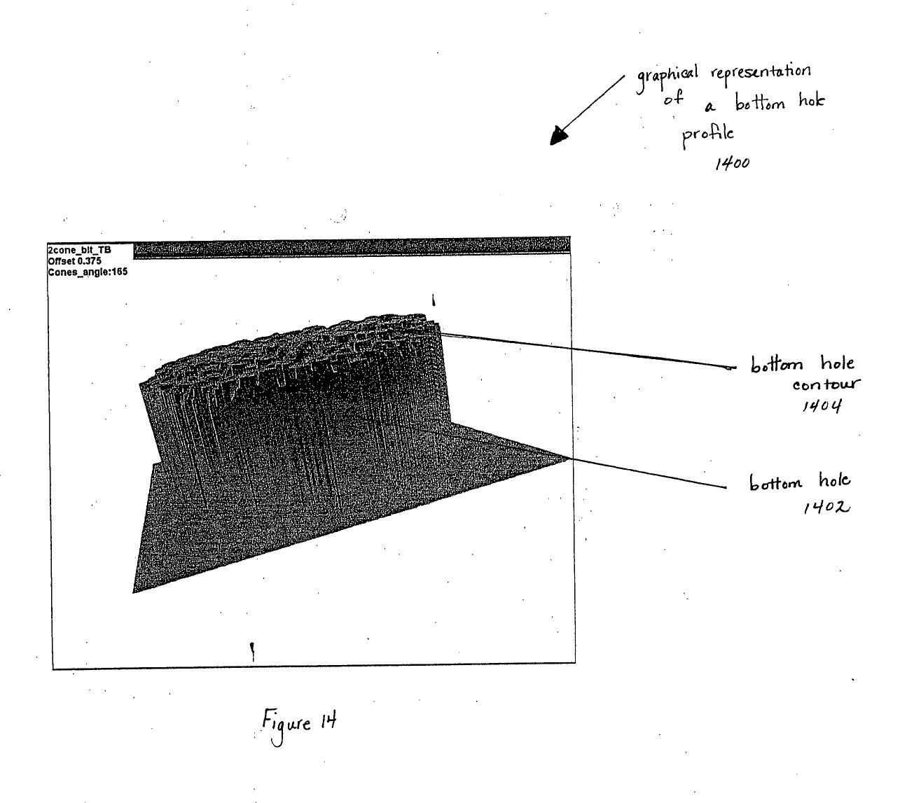

In another aspect of the invention, FIG. 12 shows a set of generalized bit bounce curves (1200). For example, the set of generalized bit bounce curves (1200) indicate the vertical displacement of the bit as it progresses through the earth formation. The set of generalized curves (1200) begins with a first iteration (1202) of a bit drilling for several revolutions and terminates with a last iteration as the result of a desired drilling depth being achieved (or the simulation being halted by a user/design engineer). During the first revolution of the first iteration (1202), the bit has not drilled into the earth formation (0 in.); however, at the end of three revolutions the bit has drilled into the formation. The last iteration (1204) shows that the bit has drilled more than five inches into the earth formation.

Typically, the first iteration (1202) may not be considered, when applying a criterion, because the bit is just beginning to drill into the earth formation. If the earth formation is a smooth planar surface, then the initial contact of the teeth of a roller cone drill bit with the earth formation may result in the first iteration of a bit bounce curve having a slope substantially equal to zero (a horizontal line). Because the first iteration is typically does not necessarily provide the steady-state of the bit, a window (1206) of the generalized bit bounce curves are considered when applying the criterion. The window (1206) includes an upper limit (1208), which is the point at which the steady-state of the bit operation is achieved and this point is measured in inches drilled through the formation. The window (1206) may also include a lower limit (1210) defined by the user to reduce the number of curves of consideration with respect to applying a criterion.

In another embodiment, the criterion may use a bottom hole profile as shown in FIG. 10. A bottom hole profile is a graphical representation of the shape of a bottom hole being drilled into the earth formation. The bottom hole profile is typically cylindrical in shape, where the terminating planar surface has a particular contour. This contour may be substantially flat, however, irregularities in the contour are expected due to rock failure breakage. The contour may also be saddle-shaped. The shape of the contour is dependent on the bit movement of the bit (axial and lateral) through the earth formation. The more stable movement through the earth formation, the more even (or flat) the contour.

In FIG. 10, the bottom hole (1004) includes a bottom hole contour (1002), which is the planar surface of the bottom hole drilled by the bit. The bottom hole contour (1002) is substantially irregular. An intersecting plan (1006) cuts the bottom hole (1004), such that the intersecting plan (1006) is equidistant between the highest peak (1010) and lowest valley (1008) of the earth formation.

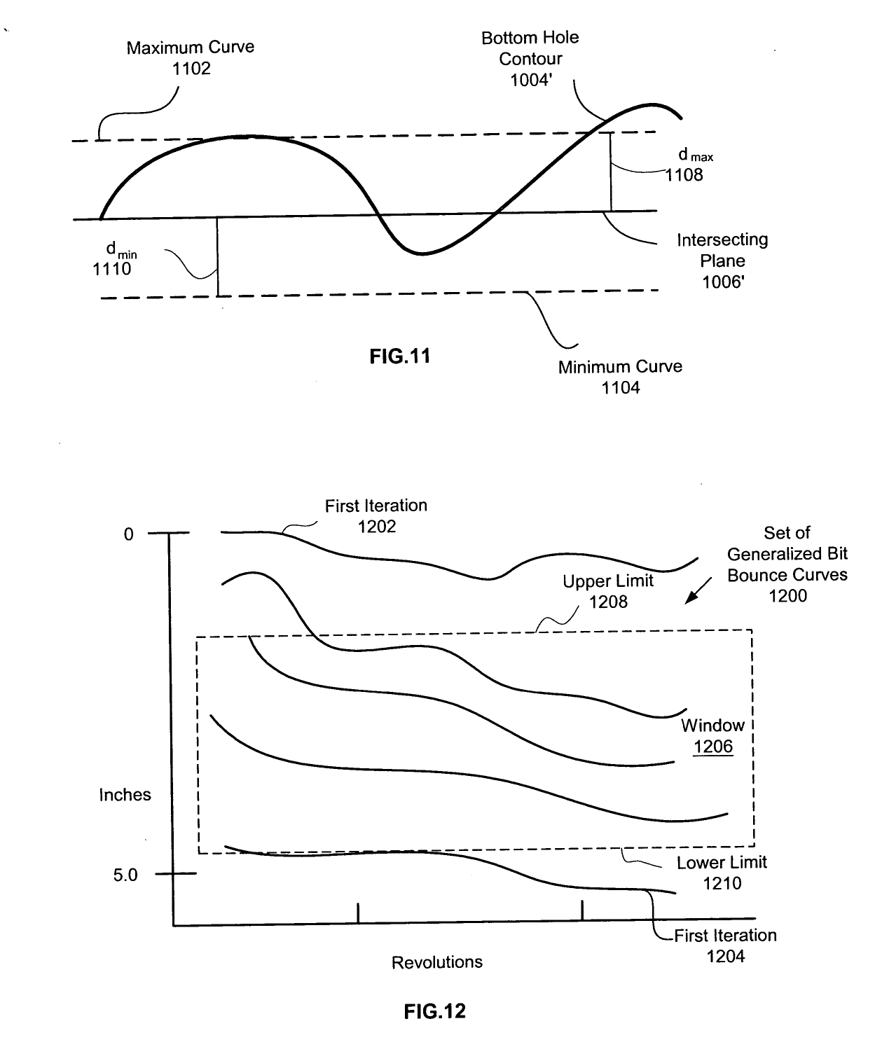

FIG. 11 shows a two-dimensional view of the bottom hole contour (1004′) and intersecting plan (1006′). Similar to the criterion as mentioned above, the maximum and minimum curves (1102, 1104) are at dₘᵢₙ and dₘₐₓ (1108, 1110) from the intersecting plane (1006′), where dₘᵢₙ and dₘₐₓ (1108, 1110) are the minimum and maximum distances that are between the intersecting plane and bottom hole contour. As shown in FIG. 11, the bottom hole contour (1004′) exceeds the maximum curve (1102). In one example, a design engineer may desire to reduce the amount which the highest peak of earth formations formed by drilling exceeds the maximum curve (1102), such that the highest peak of the bottom hole contour is less than dₘₐₓ (1108).

In Step 310, it is determined whether the current bit design satisfies the criterion. If the criterion is satisfied, then the analysis concludes. Otherwise, the optimization phase is initiated by modifying a bit parameter (Step 312) and the bit design is resimulated with the modified bit parameter (Step 314). A bit parameter may include location of cutting elements, geometry of cutting elements, orientation of bit, etc.

FIGS. 13 and 14 show exemplary representations of vertical movements obtained during simulation of a roller cone drill bit drilling through earth formations. The graph in FIG. 13 shows a graphical representation of a set of bit bounce curves (1300) as the drill bit progresses through the earth formations. The bit bounce curves have relatively flat slope and a wave-like shape. The bit bounce curves also have several spikes. The general slopes of the bit bounce curve indicate increasing penetration into the earth formation. For example, the first bit bounce curve (first iteration (1302)) starts at 0.4 inches and ends at 0.6 inches (end point (1304)), indicating at the beginning of the simulation that the bit has penetrated approximately 0.4 inches into the earth formations and at the end of the bit revolutions, the bit has penetrated approximately an additional 0.20 inches. In the last iteration, the bit bounce curve (last iteration (1306)) begins at approximately 5.40 inches (starting point (1308)) and ends at 5.60 inches (end point (1310)) into the formation.

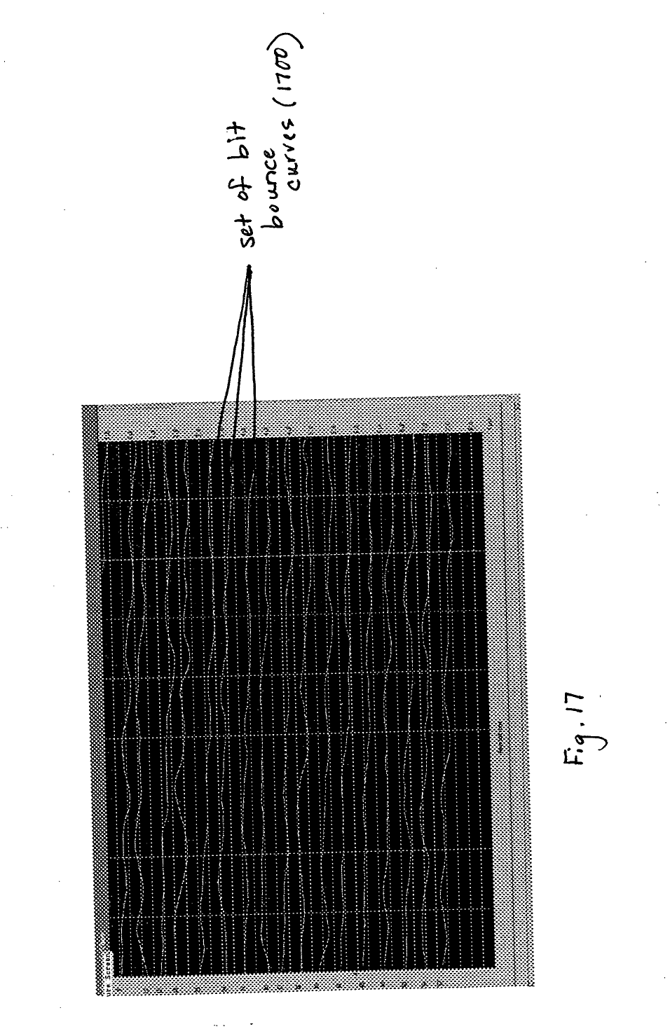

FIGS. 16 and 17 are exemplary graphical representations of generalized bit bounce curves. For example, FIG. 16 represents a first design iteration of a bit. The set of bit bounce curves (1600) are substantially wavy, indicating axial instability. FIG. 17 represents a subsequent design iteration. In this figure, the set of bit bounce curves (1700) are substantially straight, indicating an axially stable bit. Typically, a designer changes various bit parameters to improve the characteristics of the bit bounce curves.

In FIG. 14, a computer-generated graphic of a bottom hole profile (1400) is used to indicate the vertical movement of the same bit during the drilling simulation. In this case, the bottom hole (1402) that is cut by the simulated drill bit is inverted to reveal the contour (1404) of the bottom hole surface. Typically, rough, uneven surfaces indicate a lack of axial stability in a design of a drill bit, whereas smooth, even surfaces indicate an axially stable bit.

In one or more embodiments of the invention, a bottom hole assembly (BHA) may be analyzed in conjunction with a bit when determining the axial stability. Bottom hole assemblies are designed for specific application and typically include sensors, e.g., for measuring the resitivity, porosity, and density of the formation. Additionally, BHA may include pressures sensors, temperature sensors, etc. One skilled in the art will appreciate that a BHA may have a dampening or magnifying effect on the behavior of a bit bounce curve. Similarly, the BHA may have a dampening or magnifying effect on the shape of a bottom hole profile. Therefore, considering the effects of a BHA on the drilling system provides accurate analysis of a drilling operation.

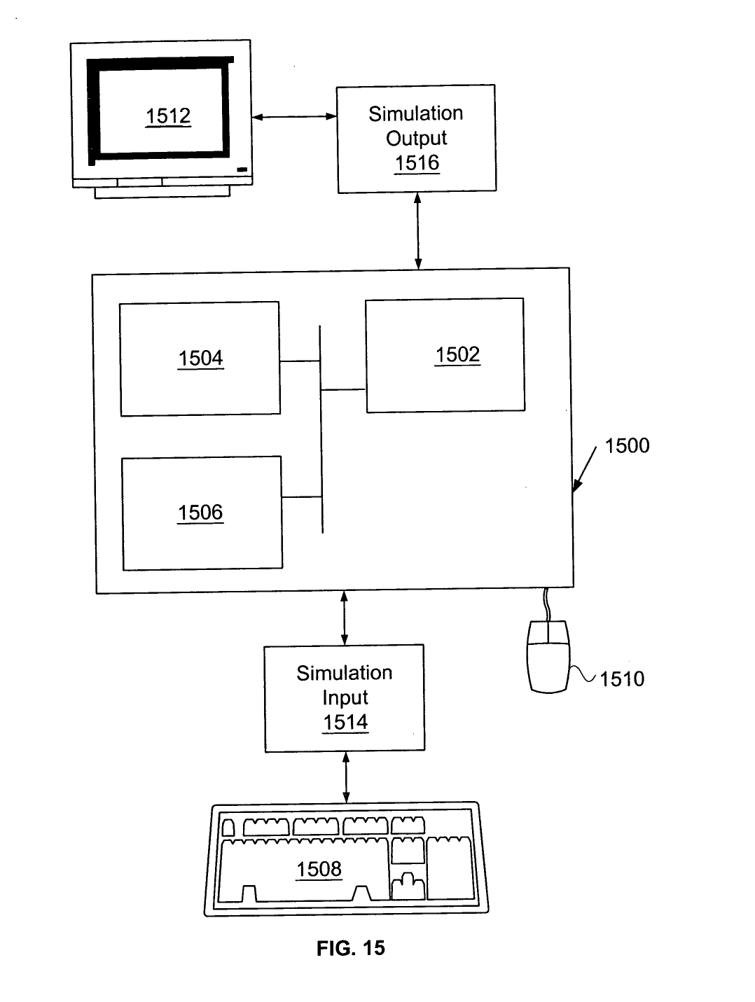

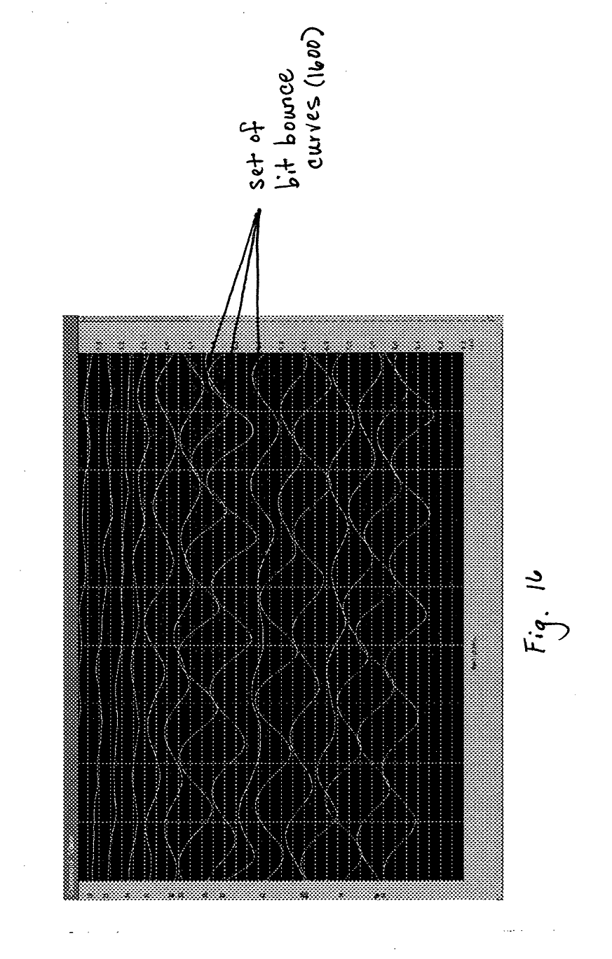

In one or more embodiments, the present invention may be implemented on virtually any type computer system regardless of the platform being used. For example, as shown in FIG. 15, a typical computer system (1500) includes a processor/simulator (1502), associated memory (1504) a storage device (1506), and numerous other elements and functionalities typical of today's computers (not shown). The computer system (1500) may also include input means, such as a keyboard (1508) and a mouse (1510), and output means, such as a monitor (1512). Those skilled in the art will appreciate that these input and output means may take other forms in an accessible environment.

In one or more embodiments, using the keyboard (1508) and/or mouse (1510), a user may input initial or modified set of parameters known as simulation input (1514). The initial or modified parameters are input to the system and used by the processor (1502) (or simulator) to execute a simulation. The results of the simulation (or simulation output (1516)) in the form of graphics (computer-generated graphics of a bit, bottom hole profile, etc.), graphs (polar plots, box-whisker plots, chart plots, etc.), tables, etc. may be output from the computer system (1500) and displayed on a monitor (1512), for example. After reviewing the simulation on the monitor (1512, a user may change a bit parameter using the mouse (1510) and reinitiate a simulation of the design on the computer system (1500).

Advantages of embodiments of the present invention may include one or more of the following. In one or more embodiments, the present invention may be used to minimize behavioral characteristics of axial instability, for example, bit bounce that reduces vibrations in the drilling string thereby improving cutting efficiency. Embodiments of the present invention can potentially increase the life of the bit by preventing damage due to repetitive impact of the cutting structure against the bottom surface of the well bore during drilling.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for designing a bit for boring earth formations, comprising:
defining parameters for a calculation, wherein the parameters relate to a geometry of the bit;
calculating to determine interference between the bit and the earth formations;
obtaining vertical displacements with respect to a bit revolution based on the interference between the bit and the earth formations; and
applying a criterion to the vertical displacements to evaluate bit performance.

2. The method of claim 1, wherein obtaining vertical displacements with respect to the bit revolution comprises generating a representation of the vertical movements.

3. The method of claim 2, wherein the representation comprises a graph of a bit bounce curve.

4. The method of claim 2, wherein the representation comprises a table of vertical displacements.

5. The method of claim 2, wherein the representation comprises a computer-generated graphic of a bottom hole profile.

6. The method of claim 1, wherein the criterion comprises a standard with respect to a number of spikes in a bit bounce curve.

7. The method of claim 1, wherein the criterion comprises a standard with respect to a wave-like shape of a bit bounce curve.

8. The method of claim 1, wherein the criterion comprises a standard with respect to a contour of a bottom hole profile.

9. The method of claim 1, wherein the criterion comprises a standard with respect to a sinusoidal shape of a bit bounce curve.

10. The method of claim 1, wherein the criterion comprises a standard with respect to a maximum vertical distance that the bit is displaced in a positive direction.

11. The method of claim 1, wherein the criterion comprises a standard with respect to a maximum vertical distance that the bit is displaced in a negative direction.

12. The method of claim 1, further comprising:
modifying one of the parameters in response to a result of applying the criterion.

13. The method of claim 12, further comprising:
recalculating the calculation with the modified parameters.

14. The method of claim 1, wherein the interference comprises interference between at least one cutting element on the bit and the earth formations.

15. A system for designing a bit in an earth formation, comprising
means for defining parameters for a calculation, wherein the parameters relate to a geometry of the bit;
means for calculating to determine interference between the bit and the earth formations;
means for obtaining vertical displacements with respect to a bit revolution based on the interference between the bit and the earth formations; and
means for applying a criterion to the vertical displacements to evaluate bit performance.

16. A method for designing a bottom hole assembly for boring earth formations, comprising:
defining parameters for a calculation, wherein the parameters relate to a geometry of a bit of the bottom hole assembly;
calculating to determine interference between the bit and the earth formations;
obtaining vertical displacements with respect to a bit revolution based on the interference between the bit and the earth formations; and
applying a criterion to the vertical displacements to evaluate bit performance with the bottom hole assembly.

17. A method for designing a bit for boring earth formation, comprising:
graphically displaying vertical displacements of the bit interfering with the earth formation; and
applying a criterion to the vertical displacements to evaluate bit performance.

18. The method of claim 17, wherein the vertical displacements are being graphically displayed as one from a group consisting of a bit bounce curve, a table, and a computer-generated graphic of a bottom hole profile.

19. The method of claim 17, further comprising:
modifying a design of the bit in response to a result of applying the criterion.

20. A method for designing a bottom hole assembly for boring earth formation, comprising:
graphically displaying vertical displacements of the bottom hole assembly as a bit of the bottom hole assembly interferes with the earth formation; and
applying a criterion to the vertical displacements to evaluate bit performance with the bottom hole assembly.

21. The method of claim 20, wherein the vertical displacements are being graphically displayed as one from a group consisting of a bit bounce curve, a table, and a computer-generated graphic of a bottom hole profile.

22. The method of claim 20, further comprising:
modifying a design of the bottom hole assembly in response to a result of applying the criterion.
